(19) United States
(12) Patent Application Publication
(10) Pub. No.: US 2026/0134168 A1
(43) Pub. Date: May 14, 2026

(54) POSE DECOUPLING KINEMATICS CALIBRATION METHOD, DEVICE AND APPARATUS, AND STORAGE MEDIUM

(71) Applicant: GUANGDONG UNIVERSITY OF TECHNOLOGY, Guangzhou (CN)

(72) Inventors: Yuheng LUO, Guangzhou (CN); Jian GAO, Guangzhou (CN); Lanyu ZHANG, Guangzhou (CN); Fuyuan FENG, Guangzhou (CN); Xin CHEN, Guangzhou (CN)

(21) Appl. No.: 19/403,562

(22) Filed: Nov. 28, 2025

Related U.S. Application Data
(63) Continuation of application No. PCT/CN2025/103433, filed on Jun. 25, 2025.

(30) Foreign Application Priority Data
Nov. 11, 2024 (CN) 202411599402.8

(51) Int. Cl. G06F 30/20; G06F 111/10

(52) U.S. Cl. CPC G06F 30/20; G06F 2111/10

(57) ABSTRACT

Disclosed are a pose decoupling kinematics calibration method, device and apparatus, and a storage medium. The method includes the following steps: constructing a pose decoupling motion model based on an equivalent rotation vector and a rigid body motion transformation rule; introducing a pose error, and carrying out pose space decomposition through the pose decoupling motion model to obtain an orientation error expression and a position equivalent expression; analyzing a coupling influence of an orientation change on a position according to the orientation error expression and the position equivalent expression to obtain a pose coupling increment; constructing a target decoupling calibration model according to the pose coupling increment and an initial decoupling calibration model; and solving geometric errors in different degrees of freedom for the target decoupling calibration model according to a preset axis pose error by a least square method to obtain a calibration error.

### CROSS-REFERENCE TO RELATED APPLICATIONS

This application is a continuation of International Patent Application No. PCT/CN2025/103433 with a filing date of Jun. 25, 2025, designating the United States, now pending, and further claims priority to Chinese Patent Application No. 202411599402.8 with a filing date of Nov. 11, 2024. The content of the aforementioned applications, including any intervening amendments thereto, are incorporated herein by reference.

### TECHNICAL FIELD

The present application relates to the technical field of mechanical motion, and particularly to a pose decoupling kinematics calibration method, device and apparatus, and a storage medium.

### BACKGROUND OF THE PRESENT INVENTION

Parts machining needs to satisfy the characteristics of complex shape, large size and high accuracy at the same time, so that it is necessary to improve a machining stroke and an operation accuracy of a multi-axis manufacturing apparatus to meet various complex requirements. Five-axis is widely used for machining complex curved surfaces because of an orientation adjustment ability, and an absolute positioning accuracy is the most critical performance index. Kinematics geometric error calibration is one of the effective ways to improve an absolute positioning accuracy of a multi-degree-of-freedom motion system. In a machining occasion where both of a position and an orientation need to maintain high accuracy, a method for minimizing an overall pose error is used in the prior art. However, due to differences in dimension, value and measurement accuracy between the position and the orientation, there may be a geometric error difference between different degrees of freedom, leading to weak convergence of some orientation errors, so that it is difficult for an overall calibration method to achieve an optimal compensation effect on the position and the orientation.

Although parameters of an orientation matrix and a position matrix in a homogeneous transformation matrix of an end-effector are decoupled in current calibration methods, an influence of the orientation on the position is not evaluated, and there is still coupling of position parameters and orientation parameters in the position matrix. Because this kind of methods fail to consider the influence of orientation on the position, it is still difficult for each degree of freedom of the mechanism to achieve optimal calibration and optimal compensation for corresponding error.

### SUMMARY OF THE PRESENT INVENTION

The present application provides a pose decoupling kinematics calibration method, device and apparatus, and a storage medium for solving the technical problem of poor calibration and compensation effects due to the fact that an influence of an orientation on a position in a multi-degree-of-freedom motion system is not considered and it is difficult to eliminate an error difference between different degrees of freedom in the prior art.

In view of this, in a first aspect, the present application provides a pose decoupling kinematics calibration method, which includes the following steps:
constructing a pose decoupling motion model based on an equivalent rotation vector and a rigid body motion transformation rule;
introducing a pose error, and carrying out pose space decomposition through the pose decoupling motion model to obtain an orientation error expression and a position equivalent expression;
analyzing a coupling influence of an orientation change on a position according to the orientation error expression and the position equivalent expression to obtain a pose coupling increment;
constructing a target decoupling calibration model according to the pose coupling increment and an initial decoupling calibration model, wherein the initial decoupling calibration model is constructed according to the pose decoupling motion model; and
solving geometric errors in different degrees of freedom for the target decoupling calibration model according to a preset axis pose error by a least square method to obtain a calibration error.

Preferably, the step of introducing the pose error, and carrying out the pose space decomposition through the pose decoupling motion model to obtain the orientation error expression and the position equivalent expression, includes:
introducing the pose error into the pose decoupling motion model to construct an error decoupling motion model;
quantitatively expressing the orientation error through the error decoupling motion model to obtain the orientation error expression; and
carrying out an equivalent rotation vector operation on the error decoupling motion model to obtain the position equivalent expression.

Preferably, the step of solving the geometric errors in different degrees of freedom for the target decoupling calibration model according to the preset axis pose error by the least square method to obtain the calibration error, includes:
allowing the preset axis pose error to include a preset axis orientation error and a preset axis position error;
solving an orientation geometric error parameter according to the preset axis orientation error and the target decoupling calibration model by the least square method;
evaluating a coupling influence degree of the orientation change on the position according to the orientation geometric error parameter to obtain a coupling increment parameter; and
solving a position geometric error parameter according to the coupling increment parameter and the target decoupling calibration model by the least square method to obtain the calibration error, wherein the calibration error includes the orientation geometric error parameter and the position geometric error parameter.

Preferably, before the step of solving the geometric errors in different degrees of freedom for the target decoupling calibration model according to the preset axis pose error by the least square method to obtain the calibration error, the method further includes the following steps:
constructing a measurement coordinate system, then acquiring rotation centers and rotation radii of the B axis and the C axis, and calculating an initial equivalent rotation vector;
solving rotation amounts of the B axis and the C axis according to collected target pose information of an end-effector and the initial equivalent rotation vector to obtain an orientation information amount; and
calculating errors of B, C, X, Y and Z axes respectively based on the orientation information amount and collected position information of X, Y and Z axes of the end-effector to obtain the preset axis orientation error and the preset axis position error.

In a second aspect, the present application provides a pose decoupling kinematics calibration device, which includes:
a model construction unit configured for constructing a pose decoupling motion model based on an equivalent rotation vector and a rigid body motion transformation rule;
a pose decomposition unit configured for introducing a pose error, and carrying out pose space decomposition through the pose decoupling motion model to obtain an orientation error expression and a position equivalent expression;
a coupling analysis unit configured for analyzing a coupling influence of an orientation change on a position according to the orientation error expression and the position equivalent expression to obtain a pose coupling increment;
a module adjustment unit configured for constructing a target decoupling calibration model according to the pose coupling increment and an initial decoupling calibration model, wherein the initial decoupling calibration model is constructed according to the pose decoupling motion model; and
a calibration solution unit configured for solving geometric errors in different degrees of freedom for the target decoupling calibration model according to a preset axis pose error by a least square method to obtain a calibration error.

Preferably, the pose decomposition unit is specifically configured for:
introducing the pose error into the pose decoupling motion model to construct an error decoupling motion model;
quantitatively expressing the orientation error through the error decoupling motion model to obtain the orientation error expression; and
carrying out an equivalent rotation vector operation on the error decoupling motion model to obtain the position equivalent expression.

Preferably, the calibration solution unit is specifically configured for:
allowing the preset axis pose error to include a preset axis orientation error and a preset axis position error;
solving an orientation geometric error parameter according to the preset axis orientation error and the target decoupling calibration model by the least square method;
evaluating a coupling influence degree of the orientation change on the position according to the orientation geometric error parameter to obtain a coupling increment parameter; and
solving a position geometric error parameter according to the coupling increment parameter and the target decoupling calibration model by the least square method to obtain the calibration error, wherein the calibration error includes the orientation geometric error parameter and the position geometric error parameter.

Optionally, the apparatus further includes:
an initial vector acquisition unit configured for constructing a measurement coordinate system, then acquiring rotation centers and rotation radii of the B axis and the C axis, and calculating an initial equivalent rotation vector;
a rotation amount calculation unit configured for solving rotation amounts of the B axis and the C axis according to collected target pose information of an end-effector and the initial equivalent rotation vector to obtain an orientation information amount; and
a pose error calculation unit configured for calculating errors of B, C, X, Y and Z axes respectively based on the orientation information amount and collected position information of X, Y and Z axes of the end-effector to obtain the preset axis orientation error and the preset axis position error.

In a third aspect, the present application provides a pose decoupling kinematics calibration apparatus, wherein the apparatus includes a processor and a storage;
the storage is used for storing a program code and transmitting the program code to the processor; and
the processor is used for executing the pose decoupling kinematics calibration method in the first aspect according to an instruction in the program code.

In a fourth aspect, the present application provides a computer-readable storage medium, wherein the computer-readable storage medium is used for storing a program code, and the program code is used for executing the pose decoupling kinematics calibration method in the first aspect.

It can be seen from the technical solution above that the embodiments of present application have the following advantages:

the present application provides the pose decoupling kinematics calibration method, which includes the following steps: constructing the pose decoupling motion model based on the equivalent rotation vector and the rigid body motion transformation rule; introducing the pose error, and carrying out the pose space decomposition through the pose decoupling motion model to obtain the orientation error expression and the position equivalent expression; analyzing the coupling influence of the orientation change on the position according to the orientation error expression and the position equivalent expression to obtain the pose coupling increment; constructing the target decoupling calibration model according to the pose coupling increment and the initial decoupling calibration model, wherein the initial decoupling calibration model is constructed according to the pose decoupling motion model; and solving the geometric errors in different degrees of freedom for the target decoupling calibration model according to the preset axis pose error by the least square method to obtain the calibration error.

According to the pose decoupling kinematics calibration method provided by the present application, the pose decoupling calibration scheme based on the equivalent rotation vector is provided, which not only carries out the pose space decomposition through the pose decoupling motion model to obtain independent expressions of the orientation and the position, but also analyzes the coupling influence of the orientation on the position based on independent expression models to obtain the accurate pose coupling increment; and then, the calibration model is adjusted according to the pose coupling increment and solved, so that it is ensured that the geometric errors in different degrees of freedom solved are accurate, and because decoupled orientation and position errors may be converged respectively, and a position motion is not affected by coupling, this process can ensure optimal calibration and satisfy requirements of error compensation. Therefore, the present application can solve the technical problem of poor calibration and compensation effects due to the fact that the influence of the orientation on the position in the multi-degree-of-freedom motion system is not considered and it is difficult to eliminate the error difference between different degrees of freedom in the prior art.

### DESCRIPTION OF THE DRAWINGS

FIG. 1 is a flow chart of a pose decoupling kinematics calibration method provided by an embodiment of the present application;

FIG. 2 is a schematic structural diagram of a pose decoupling kinematics calibration device provided by the embodiment of the present application;

FIG. 3 is a schematic diagram of a construction process of a pose decoupling motion model based on an equivalent rotation vector provided by the embodiment of the present application; and

FIG. 4 is a structure principle diagram of a pose based on the pose decoupling motion model provided by the embodiment of the present application.

### DETAILED DESCRIPTION OF PREFERRED EMBODIMENTS

In order to make those skilled in the art better understand the solution of the present application, technical solutions in embodiments of the present application are clearly and completely described hereinafter with reference to the drawings in the embodiments of the present application. Apparently, the described embodiments are merely some but not all of the embodiments of the present application. Based on the embodiments of the present application, all other embodiments obtained by those of ordinary skills in the art without going through any creative work shall fall within the scope of protection of the present application.

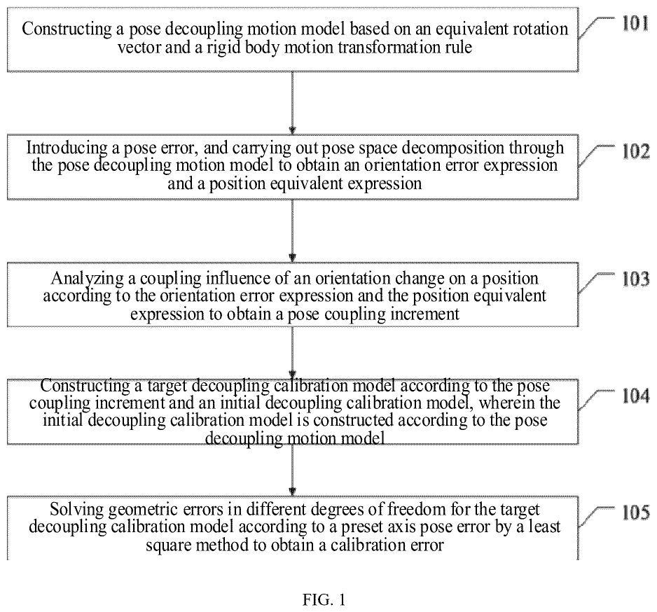

For easy understanding, with reference to FIG. 1, the present application provides a pose decoupling kinematics calibration method, which includes the following steps.

In step 101, a pose decoupling motion model is constructed based on an equivalent rotation vector and a rigid body motion transformation rule.

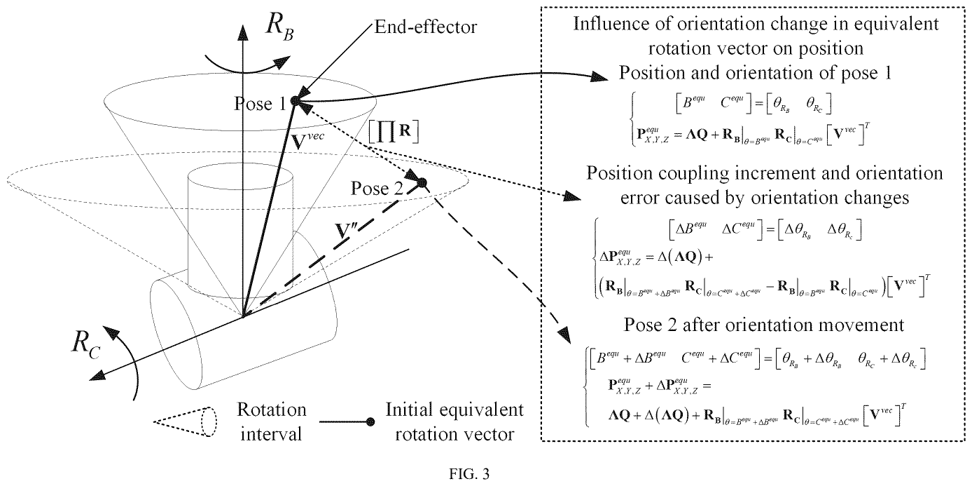

With reference to FIG. 3, a pose change of an end-effector may be regarded as left-multiplying a pose matrix ΠR by the equivalent rotation vector V^{vec}, which is specifically expressed as follows:

$${V}^{′} = [ \prod R ] {V}^{vec}$$

$$wherein , {V}^{′} = [ {v}_{x}^{′} , {v}_{y}^{′} , {v}_{z}^{′} ]$$

is a vector after an orientation change, and V^{vec}=[x^{vec}, y^{vec}, z^{vec}] is the equivalent rotation vector. When an angle between a B axis and a C axis is used for describing rotation, a change of an end-effector point may be expressed as follows:

$${R}_{B} {R}_{C} {V}^{vec} = {V}^{″}$$

$$wherein , {V}^{″} = [ {v}_{x}^{″} , {v}_{y}^{″} , {v}_{z}^{″} ] ,$$

and R_{B} and R_{C} respectively represent standard rotation matrices around a Y axis and a Z axis. When V′=V″, the following equation holds:

$${R}_{B} {R}_{C} {V}^{vec} = [ \prod R ] {V}^{vec}$$

By solving the equation, a rotation amount of the C axis may be obtained, which means that an orientation angle is

$${θ}_{{R}_{{C}_{i}}} :$$

$${θ}_{{R}_{{C}_{i}}} = arc sin ( \frac{{x}^{vec} {v}_{y}^{′}}{{( {x}^{vec} )}^{2} + {( {y}^{vec} )}^{2}} + μ \frac{{y}^{vec} \sqrt{{( {x}^{vec} )}^{2} + {( {y}^{vec} )}^{2} - {( {v}_{y}^{′} )}^{2}}}{{( {x}^{vec} )}^{2} + {( {y}^{vec} )}^{2}} ) \{ \begin{matrix}i = 1 , μ = - 1 \\ i = 2 , μ = 1\end{matrix}$$

wherein, μ is a symbolic variable for expressing different orientation angles.

On the basis of the rotation amount

$${θ}_{{R}_{{C}_{i}}}$$

of the C axis, a rotation amount of the B axis may be obtained, which means that the orientation angle is

$${θ}_{{R}_{{B}_{i}}} ;$$

$${θ}_{{R}_{{B}_{i}}} = arc sin [ \frac{{z}^{vec} {v}_{x}^{′} + {y}^{vec} {v}_{z}^{′} sin ( {θ}_{{R}_{{C}_{i}}} ) - {x}^{vec} {v}_{z}^{′} cos ( {θ}_{{R}_{{C}_{i}}} )}{{v}_{z}^{′} + {( {x}^{vec} cos ( {θ}_{{R}_{{C}_{i}}} ) - {y}^{vec} sin ( {θ}_{{R}_{{C}_{i}}} ) )}^{2}} ) i = 1 , 2$$

In this way, the pose decoupling motion model constructed based on the equivalent rotation vector may be expressed as follows:

$$\{ \begin{matrix}[ \begin{matrix}{B}^{equ} & {C}^{equ} ] = [ \begin{matrix}{θ}_{{R}_{B}} & {θ}_{{R}_{C}} ]\end{matrix}\end{matrix} \\ {P}_{X , Y , Z}^{equ} = Λ Q + {R}_{B} {\vert}_{θ = {B}^{equ}} {R}_{C} {{\vert}_{θ = {C}^{equ}} [ {V}^{vec} ]}^{T}\end{matrix}$$

wherein, ΛQ represents a position parameter component, V^{vec} is the equivalent rotation vector, which may be an initial value or a variable value for calculating a changing process, and R_{B|θ=B}_{^{equ}} and R_{C|θ=C}_{^{equ}} are respectively rotation matrices formed by the rotation amounts of the B axis and the C axis; B^{equ} and C^{equ} respectively represent equivalent orientations of the B axis and the C axis; and θ_{R}_{_{B}} and θ_{R}_{_{C}} respectively represent orientation errors calculated through the equivalent rotation vector.

In step 102, a pose error is introduced, and pose space decomposition is carried out through the pose decoupling motion model to obtain an orientation error expression and a position equivalent expression.

Further, the step 102 includes:
introducing the pose error into the pose decoupling motion model to construct an error decoupling motion model;
quantitatively expressing the orientation error through the error decoupling motion model to obtain the orientation error expression; and
carrying out an equivalent rotation vector operation on the error decoupling motion model to obtain the position equivalent expression.

It should be noted that, after introducing the pose error, the pose decoupling motion model may be expressed as the error decoupling motion model:

$$\{ \begin{matrix}[ \begin{matrix}{B}^{equ} + Δ {B}^{equ} & {C}^{equ} + Δ {C}^{equ} ] = [ \begin{matrix}{θ}_{{R}_{B}} + Δ {θ}_{{R}_{B}} & {θ}_{{R}_{C}} + Δ {θ}_{{R}_{c}}\end{matrix}\end{matrix} ] \\ {P}_{X , Y , Z}^{equ} + Δ {P}_{X , Y , Z}^{equ} = \\ Λ Q + Δ ( Λ Q ) + {R}_{B} {\vert}_{θ = {B}^{equ} + Δ {B}^{equ}} {R}_{C} {{\vert}_{θ = {C}^{equ} + Δ {C}^{equ}} [ {V}^{vec} ]}^{T}\end{matrix}$$

$$wherein , Δ {P}_{X , Y , Z}^{equ}$$

is a total position error,

$${P}_{X , Y , Z}^{equ}$$

represents a theoretical position, Δ(ΛQ) is a position error related to a position parameter, ΔB^{equ} and ΔC^{equ} respectively represent orientation errors, and Δθ_{R}_{_{B}} and Δθ_{R}_{_{C}} respectively represent orientation angle errors calculated through the equivalent rotation vector.

By quantifying specific orientation error value based on the above model, the orientation error expression may be obtained:

$$\{ \begin{matrix}Δ {B}^{e q u} = {B}^{e q u} {\vert}_{{L}^{Ω} = {L}_{JM}^{Ω}} - {B}^{e q u} {\vert}_{{L}^{Ω} = {L}_{JM}^{Ω} + Δ {L}_{JM}^{Ω}} \\ Δ {C}^{e q u} = {C}^{e q u} {\vert}_{{L}^{Ω} = {L}_{JM}^{Ω}} - {C}^{e q u} {\vert}_{{L}^{Ω} = {L}_{JM}^{Ω} + Δ {L}_{JM}^{Ω}}\end{matrix}$$

wherein, L^{Ω} represents a geometric parameter related to the orientation,

$${L}_{JM}^{Ω}$$

is a theoretical geometric parameter related to the orientation, and

$$Δ {L}_{JM}^{Ω}$$

represents a geometric parameter error related to the orientation.

By carrying out the equivalent rotation vector operation on the above model, the position equivalent expression may be obtained:

$${{[ {P}_{X , Y , Z}^{o v e} ] \vert}_{{L}^{Ω} = {L}_{JM}^{Ω} + Δ {L}_{JM}^{Ω}} = [ {P}_{X , Y , Z}^{e q u} ] \vert}_{θ = Ω + Δ Ω}$$

wherein,

$${P}_{X , Y , Z}^{o v e}$$

represents a theoretical position in the rigid body motion transformation rule, L^{Ω} represents a geometric parameter related to the orientation in the rigid body motion transformation rule,

$${L}_{JM}^{Ω} and Δ {L}_{JM}^{Ω}$$

respectively represent a theoretical geometric parameter and a geometric parameter error related to the orientation in the rigid body motion transformation rule, Ω and ΔΩ respectively represent a theoretical orientation and an orientation error in the pose decoupling motion model, and Ω=[θ_{R}_{_{B}} θ_{R}_{_{C}}].

In step 103, a coupling influence of an orientation change on a position is analyzed according to the orientation error expression and the position equivalent expression to obtain a pose coupling increment.

The coupling influence of the orientation change on the position may be analyzed according to the two expressions above, which is specifically expressed as a position coupling increment caused by the orientation change, for example, the pose coupling increment:

$${{Δ {P}_{X , Y , Z}^{{B}^{e q u} + {C}^{e q u}} = [ {P}_{X , Y , Z}^{e q u} ] \vert}_{θ = Ω + Δ Ω} - [ {P}_{X , Y , Z}^{e q u} ] \vert}_{θ = Ω}$$

A pose may be decoupled into independent expressions in space through the pose decoupling motion model, and then, on this basis, the position coupling increment caused by the orientation change is analyzed, and an influence expression model under orientation and position decoupling is constructed. Because of the independent expressions of the orientation and the position, both of the orientation and the position may be converged in metric spaces respectively to achieve the purpose of optimal error compensation; and moreover, in the present application, the coupling influence of the orientation on the position is considered, so that it is ensured that a calibration process conforms to actual situations, thereby achieving a better calibration effect.

In step 104, a target decoupling calibration model is constructed according to the pose coupling increment and an initial decoupling calibration model, wherein the initial decoupling calibration model is constructed according to the pose decoupling motion model.

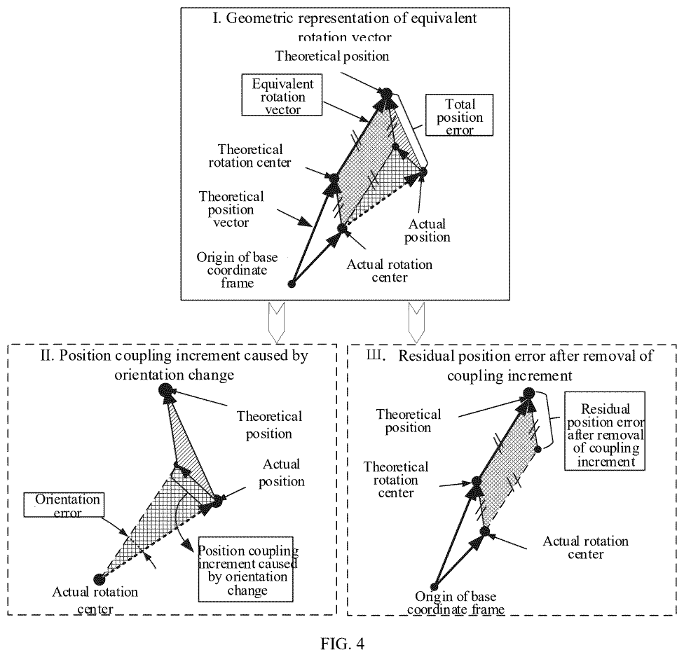

A pose decoupling process of the pose decoupling motion model constructed based on the equivalent rotation vector refers to FIG. 4, and an influence of the pose coupling increment is considered in this process. A specific process refers to constructing the initial decoupling calibration model according to the pose decoupling motion model:

$$\{ \begin{matrix}Δ {Ω}_{B , C} = {J}_{Ω} Δ {L}_{Ω} \\ Δ {P}_{X , Y , Z} = {J}_{P} Δ {L}_{P}\end{matrix}$$

wherein, ΔΩ_{B,C}=[ΔB ΔC]^{T} is an orientation error vector of an end-effector after data collection and transformation, ΔB and ΔC respectively represent orientation errors of the B axis and the C axis after data collection and transformation, J_{Ω}=[J_{B} J_{C}]^{T} is an orientation error mapping matrix, J_{B} and J_{C} respectively represent error mapping matrices of the B axis and the C axis, ΔL_{Ω} represents a geometric parameter error related to the orientation; and ΔP_{X,Y,Z}=[ΔX ΔY ΔZ]^{T} is a position error of the end-effector, wherein, ΔX, ΔY and ΔZ represent position errors of X, Y and Z axes, J_{P}=[J_{X} J_{Y} J_{Z}]^{T} is a position error mapping matrix, J_{X}, J_{Y} and J_{Z} respectively represent error mapping matrices of the X, Y and Z axes; and ΔL_{P} represents a geometric parameter error related to the position.

It is considered that there are two types of position errors, one type of position error is an error caused by the orientation change, and the other type of position error is an error caused by an inherent error of a position geometric parameter. In this embodiment, a coupling effect of the orientation and the position is considered, and a residual position error after removal of an orientation-induced position coupling increment may be obtained:

$${ΔP}_{R E S} = Δ {P}_{X , Y , Z} - Δ {P}_{X , Y , Z}^{{B}^{e q u} + {C}^{e q u}} wherein , Δ {P}_{X ,}^{{B}^{e q u} + {C}^{e q u}}$$

is the pose coupling increment, and ΔP_{X,Y,Z} is the position error of the end-effector. After coupling adjustment, the target decoupling calibration model is expressed as follows:

$$\{ \begin{matrix}Δ Ω = {J}_{Ω} Δ {L}_{Ω} \\ Δ {P}_{R E S} = {J}_{P} Δ {L}_{P}\end{matrix}$$

wherein, ΔP_{RES} represents the residual position error after removal of the orientation-induced position coupling increment.

In step 105, geometric errors in different degrees of freedom are solved for the target decoupling calibration model according to a preset axis pose error by a least square method to obtain a calibration error.

Further, the step 105 includes:
allowing the preset axis pose error to include a preset axis orientation error and a preset axis position error;
solving an orientation geometric error parameter according to the preset axis orientation error and the target decoupling calibration model by the least square method;
evaluating a coupling influence degree of the orientation change on the position according to the orientation geometric error parameter to obtain a coupling increment parameter; and
solving a position geometric error parameter according to the coupling increment parameter and the target decoupling calibration model by the least square method to obtain the calibration error, wherein the calibration error includes the orientation geometric error parameter and the position geometric error parameter.

Further, before the step 105, the method further includes the following steps:
constructing a measurement coordinate system, then acquiring rotation centers and rotation radii of the B axis and the C axis, and calculating an initial equivalent rotation vector;
solving rotation amounts of the B axis and the C axis according to collected target pose information of an end-effector and the initial equivalent rotation vector to obtain an orientation information amount; and
calculating errors of B, C, X, Y and Z axes respectively based on the orientation information amount and collected position information of X, Y and Z axes of the end-effector to obtain the preset axis orientation error and the preset axis position error.

It should be noted that a formula for solving the target decoupling calibration model may be expressed as follows:

$$\{ \begin{matrix}Δ {L}_{Ω} = {( {J}_{Ω}^{T} {J}_{Ω} )}^{- 1} {J}_{Ω} Δ Ω ( a ) \\ Δ {L}_{P} = {( {J}_{P}^{T} {J}_{P} )}^{- 1} {J}_{P} Δ {P}_{R E S} ( b )\end{matrix}$$

The solution after successful construction of the target decoupling calibration model needs to be carried out based on the preset axis pose error, which refers to the preset axis orientation error and the preset axis position error, and the two parameters are pre-calculated data. A specific process includes constructing the measurement coordinate system: moving along the X axis and the Y axis, and constructing the measurement coordinate system X′ Y′ Z′ through linear fitting; and then, obtaining rotation trajectories of the B axis and the C axis through the measurement system, so as to obtain rotation centers of the B axis and the C axis, acquiring rotation paths of the B axis and the C axis and a radius L_{Rb} of the B axis through circular fitting, taking an intersection of the rotation paths of the B axis and the C axis as a measuring head, and taking all of the data as initial parameters for subsequent calculation. In addition to acquiring the rotation parameters of the B axis and the C axis, some initial projection components also need to be collected to calculate the initial equivalent rotation vector; and coordinates O_{c} from the measuring head to the rotation center of the C axis are taken as projection components x^{las} and y^{las} in X and Y directions, a projection component

$${z}^{l a s} = \sqrt{{L}_{R b}^{2} - {( {x}^{l a s} )}^{2}}$$

of the Z axis is calculated according to the radius L_{Rb} of the B axis, and the initial equivalent rotation vector calculated is expressed as follows:

$${V}^{v e r} = {[ {X}^{las} {y}^{las} \sqrt{{L}_{R b}^{2} - {( {x}^{las} )}^{2}} ]}^{T}$$

In addition, it is necessary to collect the pose information of the end-effector by a vision system or a laser tracker, including an orientation matrix ΠR and a position matrix P; and according to information of the orientation matrix ΠR and the initial equivalent rotation vector, actual rotation amounts and theoretical rotation amounts of the B axis and the C axis may be solved, which refer to the orientation information amount, and an orientation error ΔΩ of the end-effector may be calculated by taking a difference between the actual rotation amount and the theoretical rotation amount. A position error ΔP of the end-effector may be calculated by taking a difference between the actually acquired position matrix P which is axis position information and the theoretical position, which is the preset axis orientation error and the preset axis position error.

According to the preset axis orientation error solved, the orientation geometric error parameter may be solved, which refers to a solution formula (a) of the target decoupling calibration model; according to the orientation geometric error parameter solved, the coupling influence of the orientation change on the position may be evaluated to obtain the coupling increment parameters; and according to the coupling increment parameter and the preset axis position error, a solution formula (b) of the target decoupling calibration model may be solved to obtain the position geometric error parameter. The orientation geometric error parameter and the position geometric error parameter are the calibration errors; and based on the calibration errors, optimal calibration can be achieved and optimal error compensation is satisfied.

According to the pose decoupling kinematics calibration method provided by the embodiment of the present application, the pose decoupling calibration scheme based on the equivalent rotation vector is provided, which not only carries out the pose space decomposition through the pose decoupling motion model to obtain independent expressions of the orientation and the position, but also analyzes the coupling influence of the orientation on the position based on independent expression models to obtain the accurate pose coupling increment; and then, the calibration model is adjusted according to the pose coupling increment and solved, so that it is ensured that the geometric errors in different degrees of freedom solved are accurate, and because decoupled orientation and position errors may be converged respectively, and a position motion is not affected by coupling, this process can ensure optimal calibration and satisfy requirements of error compensation. Therefore, the embodiment of the present application can solve the technical problem of poor calibration and compensation effects due to the fact that the influence of orientation the the on the position in multi-degree-of-freedom motion system is not considered and it is difficult to eliminate the error difference between different degrees of freedom in the prior art.

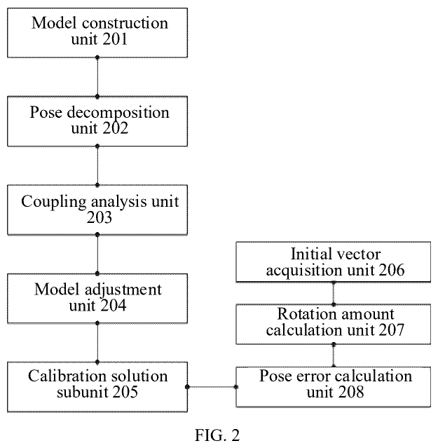

For easy understanding, with reference to FIG. 2, the present application provides a pose decoupling kinematics calibration device, which includes:
a model construction unit 201 configured for constructing a pose decoupling motion model based on an equivalent rotation vector and a rigid body motion transformation rule;
a pose decomposition unit 202 configured for introducing a pose error, and carrying out pose space decomposition through the pose decoupling motion model to obtain an orientation error expression and a position equivalent expression;
a coupling analysis unit 203 configured for analyzing a coupling influence of an orientation change on a position according to the orientation error expression and the position equivalent expression to obtain a pose coupling increment;
a module adjustment unit 204 configured for constructing a target decoupling calibration model according to the pose coupling increment and an initial decoupling calibration model, wherein the initial decoupling calibration model is constructed according to the pose decoupling motion model; and
a calibration solution unit 205 configured for solving geometric errors in different degrees of freedom for the target decoupling calibration model according to a preset axis pose error by a least square method to obtain a calibration error.

Further, the pose decomposition unit 202 is specifically configured for:
introducing the pose error into the pose decoupling motion model to construct an error decoupling motion model;
quantitatively expressing the orientation error through the error decoupling motion model to obtain the orientation error expression; and
carrying out an equivalent rotation vector operation on the error decoupling motion model to obtain the position equivalent expression.

Further, the calibration solution unit 205 is specifically configured for:
allowing the preset axis pose error to include a preset axis orientation error and a preset axis position error;
solving an orientation geometric error parameter according to the preset axis orientation error and the target decoupling calibration model by the least square method;
evaluating a coupling influence degree of the orientation change on the position according to the orientation geometric error parameter to obtain a coupling increment parameter; and
solving a position geometric error parameter according to the coupling increment parameter and the target decoupling calibration model by the least square method to obtain the calibration error, wherein the calibration error includes the orientation geometric error parameter and the position geometric error parameter.

Further, the device further includes:
an initial vector acquisition unit 206 configured for constructing a measurement coordinate system, then acquiring rotation centers and rotation radii of the B axis and the C axis, and calculating an initial equivalent rotation vector;
a rotation amount calculation unit 207 configured for solving rotation amounts of the B axis and the C axis according to collected target pose information of an end-effector and the initial equivalent rotation vector to obtain an orientation information amount; and
a pose error calculation unit 208 configured for calculating errors of B, C, X, Y and Z axes respectively based on the orientation information amount and collected position information of X, Y and Z axes of the end-effector to obtain the preset axis orientation error and the preset axis position error.

The present application further provides a pose decoupling kinematics calibration apparatus, wherein the apparatus includes a processor and a storage;
the storage is used for storing a program code and transmitting the program code to the processor; and
the processor is used for executing the pose decoupling kinematics calibration method in the above method embodiment according to an instruction in the program code.

The present application further provides a computer-readable storage medium, wherein the computer-readable storage medium is used for storing a program code, and the program code is used for executing the pose decoupling kinematics calibration method in the above method embodiment.

In the several embodiments provided in the present application, it should be understood that the disclosed device and method may be implemented in other ways. For example, the foregoing device embodiments are only illustrative. For example, the division of the units is only one logical function division. In practice, there may be other division methods. For example, multiple units or assemblies may be combined or integrated into another system, or some features may be ignored or not executed. In addition, the illustrated or discussed mutual coupling or direct coupling or communication connection may be indirect coupling or communication connection through some interfaces, devices or units, and may be in electrical, mechanical or other forms.

The units illustrated as separated parts may be or not be physically separated, and the parts displayed as units may be or not be physical units, which means that the parts may be located in one place or distributed on multiple network units. Some or all of the units may be selected according to actual needs to achieve the objectives of the solutions of the embodiments.

In addition, each functional unit in each embodiment of the present application may be integrated in one processing unit, or each unit may exist alone physically, or two or more units may be integrated in one unit. The integrated units above may be implemented in a form of hardware, or may be implemented in a form of software functional unit.

The integrated units, if being implemented in the form of software functional unit and taken as an independent product to sell or use, may also be stored in one computer-readable storage Based on such understanding, the essence of the technical solution of the present application, or a part contributing to the prior art, or all or a part of the technical solution may be embodied in a form of software product. The computer software product is stored in one storage medium including a number of instructions such that a computer device (which may be a personal computer, a server, or a network device, etc.) executes all or a part of steps of the method in the embodiments of the present application. Moreover, the foregoing storage medium includes: various media capable of storing the program code, such as a USB disk, a mobile hard disk, a Read-Only Memory (ROM), a Random Access Memory (RAM), a magnetic disk or an optical disk.

As described above, the embodiments above are only used to illustrate the technical solutions of the present application, and are not intended to limit the present application. Although the present application has been described in detail with reference to the above-mentioned embodiments, those of ordinary skills in the art shall understand that: the technical solutions recorded in the above-mentioned embodiments can still be modified, or equivalent substitutions can be made to a part of the technical features in the embodiments. However, these modifications or substitutions shall not depart from the spirit and scope of the technical solutions of the embodiment's of the present application.

We claim:

1. A pose decoupling kinematics calibration method, comprising the following steps:
constructing a pose decoupling motion model based on an equivalent rotation vector and a rigid body motion transformation rule, wherein the pose decoupling motion model is expressed as follows:
$$\{ \begin{matrix}[ {B}^{e q u} {C}^{e q u} ] = [ {θ}_{{R}_{B}} {θ}_{{R}_{C}} ] \\ {{{{P}_{X , Y , Z}^{e q u} = Λ Q + {R}_{B} \vert}_{θ = {B}^{e q u}} {R}_{c} \vert}_{θ = {C}^{e q u}} [ {V}^{v e c} ]}^{T}\end{matrix} wherein , {P}_{X ,}^{e q u}$$
is a theoretical position, ΛQ represents a position parameter component, V^{vec} is the equivalent rotation vector, which is an initial value or a variable value for calculating a changing process, and R_{B|θ=B}_{^{equ}} and R_{C|θ=C}_{^{equ}} are respectively rotation matrices formed by rotation amounts of a B axis and a C axis; B^{equ} and C^{equ} respectively represent equivalent orientations of the B axis and the C axis; and θ_{R}_{_{B}} and θ_{R}_{_{c}} respectively represent orientation errors calculated through the equivalent rotation vector;
introducing a pose error, and carrying out pose space decomposition through the pose decoupling motion model to obtain an orientation error expression and a position equivalent expression;
analyzing a coupling influence of an orientation change on a position according to the orientation error expression and the position equivalent expression to obtain a pose coupling increment, wherein the pose coupling increment is expressed as follows:
$${{Δ {P}_{X , Y , Z}^{{B}^{e q u} + {C}^{e q u}} = [ {P}_{X , Y , Z}^{e q u} ] \vert}_{θ = Ω + ΔΩ} - [ {P}_{X , Y , Z}^{e q u} ] \vert}_{θ = Ω}$$
wherein, Ω and ΔΩ respectively represent a theoretical orientation and an orientation error in the pose decoupling motion model, and Ω=[θ_{R}_{_{B}} θ_{R}_{_{C}}];
constructing a target decoupling calibration model according to the pose coupling increment and an initial decoupling calibration model, wherein the initial decoupling calibration model is constructed according to the pose decoupling motion model; and
solving geometric errors in different degrees of freedom for the target decoupling calibration model according to a preset axis pose error by a least square method to obtain a calibration error.

2. The pose decoupling kinematics calibration method according to claim 1, wherein, the step of introducing the pose error, and carrying out the pose space decomposition through the pose decoupling motion model to obtain the orientation error expression and the position equivalent expression, comprises:
introducing the pose error into the pose decoupling motion model to construct an error decoupling motion model;
quantitatively expressing the orientation error through the error decoupling motion model to obtain the orientation error expression; and
carrying out an equivalent rotation vector operation on the error decoupling motion model to obtain the position equivalent expression.

3. The pose decoupling kinematics calibration method according to claim 1, wherein the step of solving the geometric errors in different degrees of freedom for the target decoupling calibration model according to the preset axis pose error by the least square method to obtain the calibration error, comprises:
allowing the preset axis pose error to comprise a preset axis orientation error and a preset axis position error;
solving an orientation geometric error parameter according to the preset axis orientation error and the target decoupling calibration model by the least square method;
evaluating a coupling influence degree of the orientation change on the position according to the orientation geometric error parameter to obtain a coupling increment parameter; and
solving a position geometric error parameter according to the coupling increment parameter and the target decoupling calibration model by the least square method to obtain the calibration error, wherein the calibration error comprises the orientation geometric error parameter and the position geometric error parameter.

4. The pose decoupling kinematics calibration method according to claim 1, wherein before the step of solving the geometric errors in different degrees of freedom for the target decoupling calibration model according to the preset axis pose error by the least square method to obtain the calibration error, the method further comprises the following steps:
constructing a measurement coordinate system, then acquiring rotation centers and rotation radii of the B axis and the C axis, and calculating an initial equivalent rotation vector;
solving rotation amounts of the B axis and the C axis according to collected target pose information of an end-effector and the initial equivalent rotation vector to obtain an orientation information amount; and
calculating errors of B, C, X, Y and Z axes respectively based on the orientation information amount and collected position information of X, Y and Z axes of the end-effector to obtain the preset axis orientation error and the preset axis position error.

5. A pose decoupling kinematics calibration device, comprising:
a model construction unit configured for constructing a pose decoupling motion model based on an equivalent rotation vector and a rigid body motion transformation rule, wherein the pose decoupling motion model is expressed as follows:
$$\{ \begin{matrix}[ {B}^{e q u} {C}^{e q u} ] = [ {θ}_{{R}_{B}} {θ}_{{R}_{C}} ] \\ {{{{P}_{X , Y , Z}^{e q u} = Λ Q + {R}_{B} \vert}_{θ = {B}^{e q u}} {R}_{C} \vert}_{θ = {C}^{e q u}} [ {V}^{v e c} ]}^{T}\end{matrix} wherein , {P}_{X , Y , Z}^{e q u}$$
is a theoretical position, ΛQ represents a position parameter component, V^{vec} is the equivalent rotation vector, which is an initial value or a variable value for calculating a changing process, and R_{B|θ=B}_{^{equ}} and R_{C|θ=C}_{^{equ}} are respectively rotation matrices formed by rotation amounts of a B axis and a C axis; B^{equ} and C^{equ} respectively represent equivalent orientations of the B axis and the C axis; and θ_{R}_{_{B}} and θ_{R}_{_{C}} respectively represent orientation errors calculated through the equivalent rotation vector;
a pose decomposition unit configured for introducing a pose error, and carrying out pose space decomposition through the pose decoupling motion model to obtain an orientation error expression and a position equivalent expression;
a coupling analysis unit configured for analyzing a coupling influence of an orientation change on a position according to the orientation error expression and the position equivalent expression to obtain a pose coupling increment, wherein the pose coupling increment is expressed as follows:
$${{Δ {P}_{X , Y , Z}^{{B}^{e q u} + {C}^{e q u}} = [ {P}_{X , Y , Z}^{e q u} ] \vert}_{θ = Ω + ΔΩ} - [ {P}_{X , Y , Z}^{e q u} ] \vert}_{θ = Ω}$$
wherein, Ω and ΔΩ respectively represent a theoretical orientation and an orientation error in the pose decoupling motion model, and Ω=[θ_{R}_{_{B}} θ_{R}_{_{C}}];
a module adjustment unit configured for constructing a target decoupling calibration model according to the pose coupling increment and an initial decoupling calibration model, wherein the initial decoupling calibration model is constructed according to the pose decoupling motion model; and
a calibration solution unit configured for solving geometric errors in different degrees of freedom for the target decoupling calibration model according to a preset axis pose error by a least square method to obtain a calibration error.

6. The pose decoupling kinematics calibration device according to claim 5, wherein the pose decomposition unit is specifically configured for:
introducing the pose error into the pose decoupling motion model to construct an error decoupling motion model;
quantitatively expressing the orientation error through the error decoupling motion model to obtain the orientation error expression; and
carrying out an equivalent rotation vector operation on the error decoupling motion model to obtain the position equivalent expression.

7. The pose decoupling kinematics calibration device according to claim 5, wherein the calibration solution unit is specifically configured for:
allowing the preset axis pose error to comprise a preset axis orientation error and a preset axis position error;
solving an orientation geometric error parameter according to the preset axis orientation error and the target decoupling calibration model by the least square method;
evaluating a coupling influence degree of the orientation change on the position according to the orientation geometric error parameter to obtain a coupling increment parameter; and
solving a position geometric error parameter according to the coupling increment parameter and the target decoupling calibration model by the least square method to obtain the calibration error, wherein the calibration error comprises the orientation geometric error parameter and the position geometric error parameter.

8. The pose decoupling kinematics calibration device according to claim 5, further comprising:
an initial vector acquisition unit configured for constructing a measurement coordinate system, then acquiring rotation centers and rotation radii of the B axis and the C axis, and calculating an initial equivalent rotation vector;
a rotation amount calculation unit configured for solving rotation amounts of the B axis and the C axis according to collected target pose information of an end-effector and the initial equivalent rotation vector to obtain an orientation information amount; and
a pose error calculation unit configured for calculating errors of B, C, X, Y and Z axes respectively based on the orientation information amount and collected position information of X, Y and Z axes of the end-effector to obtain the preset axis orientation error and the preset axis position error.

9. A pose decoupling kinematics calibration apparatus, wherein the apparatus comprises a processor and a storage;
the storage is used for storing a program code and transmitting the program code to the processor; and
the processor is used for executing the pose decoupling kinematics calibration method according to any one of claims 1 to 4 according to an instruction in the program code.

10. A computer-readable storage medium, wherein the computer-readable storage medium is used for storing a program code, and the program code is used for executing the pose decoupling kinematics calibration method according to claim 1.
